(19) United States
(12) Patent Application Publication
(10) Pub. No.: US 2007/0117552 A1
(43) Pub. Date: May 24, 2007

(54) Push to talk over cellular having productive use of dead time and inclusion of diverse participants

(75) Inventors: Venkata T. Gobburu, San Jose, CA (US); Nagesh Challa, Saratoga, CA (US); Michel E. Gannage, Los Altos Hills, CA (US)

Correspondence Address: ALTERA LAW GROUP, LLC, 6500 CITY WEST PARKWAY, SUITE 100, MINNEAPOLIS, MN, 55344-7704, US

(73) Assignee: Ecrio, Inc.

(21) Appl. No.: 11/651,127

(22) Filed: Jan. 9, 2007

Related U.S. Application Data
(60) Provisional application No. 60/757,749, filed on Jan. 9, 2006.
(60) Provisional application No. 60/830,925, filed on Jul. 14, 2006.

(51) Int. Cl. H04Q 7/38

(52) U.S. Cl. 455/414.1

(57) ABSTRACT

Various communications clients such as, for example, Push to Talk over Cellular (“PoC”) client applications and PoC devices provided with client applications, provide extended services such as filler information for dead time intervals, and communication of PoC session content with non-PoC subscribers and with PoC subscribers who are offline. Through the use of one or more client applications to provide these extended services, the user experience is enriched and operators may monetize these extended services without need to modify the operating system or the network.

### CROSS-REFERENCE TO RELATED APPLICATIONS

This patent application claims the benefit of U.S. Provisional Patent Application Ser. No. 60/757,749 filed Jan. 9, 2006 in the name of Gobburu et al. and entitl4ed “Next generation applications for mobile communications” (Attorney Docket No. 01810.0022-US-P1), which hereby is incorporated herein in its entirety by reference thereto; and further claims the benefit of U.S. Provisional Patent Application Ser. No. 60/830,925 filed Jul. 14, 2006 in the name of Gobburu et al. and entitled “Next generation applications for mobile communications” (Attorney Docket No. 01810.0022-US-P2), which hereby is incorporated herein in its entirety by reference thereto.

### BACKGROUND OF THE INVENTION

1. Field of the Invention

The present invention relates to next generation applications for mobile communications, and more particularly to improving the Push to Talk Over Cellular (“PoC”) experience by the productive use of dead time and inclusion of diverse participants.

2. Description of the Related Art

Global convergence and interoperability among fixed and mobile networks and advanced applications such as instant messaging, picture messaging, mobile TV, Push to Talk, VoIP, audio and video streaming, and presence and availability updates are envisioned for high speed internet connected phones and other mobile cellular-enabled devices using advanced networks such as 3 G networks being deployed by operators worldwide. Particularly useful solutions which enable the next generation of communications applications include Instant Messaging and Presence Services (“IMPS”), Push to Talk over Cellular (“PoC”), and its extensions over the next generation infrastructure—Internet Protocol Multimedia Subsystem (“IMS”).

While the advanced networks provide significantly improved PoC performance over their predecessors, many conditions can delay the completion of PoC exchanges, including long transit times that are routine in some systems, poor signal quality, temporary system delays due to heavy traffic or network problems, heavy site traffic, and so forth. These conditions can result in “dead time,” during which the screen used to initiate the PoC exchange remains statically displayed on the client, or the client screen simply goes blank or displays an incomplete screen relating to the PoC exchange, or displays a screensaver, or is otherwise not constructively communicating information.

While PoC sessions are very convenient and intuitive to PoC subscribers, non-subscribers are generally excluded. A conventional PoC exchange is like a walkie talkie in that after a name is selected, a talk button is pressed and the user “holds the floor” for as long as the talk button is pressed. When the user lets go of button, she lets go of the floor. For one user to reach another, both must have upgraded phones, have signed up for the service, and be online. This limits the usefulness of conventional PoC systems.

In summary, while PoC is convenient and powerful, the presence of dead time during sessions can irritate users, and the inability to easily include non-subscribers in sessions limits the usefulness of PoC for group communications. Even as the duration of dead time intervals lessens due to improved efficiencies of the networks, monetizing the PoC service with advertisement would a benefit for the operators.

### BRIEF SUMMARY OF THE INVENTION

The presence of dead time in communications sessions is advantageously used as an opportunity to present useful information to the user. A client application may be provided to display filler information in response to the occurrence of dead time, for example. The screen from which the PoC exchange is initiated is replaced by a new screen which contains the useful information.

In particular, some of the embodiments of the present invention concern a dead time filler. The focus may be on a mobile terminal or device such as a phone, smart phone, or PDA with communications capability, a tablet computer with communications capability, and so forth. The application may be a standards-based PoC application specifically, or an application based on the push-to-talk concepts of floor control and the like such as, for example, Push-to-Show. Suitable information delivered by a dead time filler may include (a) promotional material deemed suitable by a service provider either for bringing in additional revenues or subsidizing the service offering, even to the extend of offering a free service; (b) personal material such as that delivered through a second, independent communications application such as Email or SMS through horizontal integration; (c) is “actionable,” that is, allows the loop to be closed to help make purchases; (d) reports back through a second, independent application through horizontal integration; and so forth.

One embodiment of the present invention, for example, is a method of using dead time arising from a communications exchange over a network. The method comprises acquiring filler information; identifying a dead time interval relating to communications over the network; and displaying the filler information at least during a part of the dead time interval. In a further specific embodiment, the communications exchange is a Push to Talk over Cellular (“PoC”) exchange.

Another embodiment of the present invention is a communications client for carrying out a communications exchange over a network. The communications client comprises a plurality of stored program instructions for acquiring filler information; identifying a dead time interval relating to communications over the network; and displaying the filler information at least during a part of the dead time interval. The communications client may be a PoC client device such as PoC mobile phone, a PoC personal data assistant, or a PoC notebook computer, or may be a digital information storage medium.

The problem of not being able to easily include non-subscribers and offline subscribers in PoC sessions is also solved by the present invention. Advantageously, a client application may be provided with the capability of allowing PoC session information to be communicated to any arbitrary mix of PoC, Email, SMS, and other types of users.

In particular, some of the embodiments of the present invention concern Email extensions for PoC client device. The focus may be on a mobile terminal or device such as a phone, smart phone, or PDA with communications capability, a tablet computer with communications capability, and so forth. The application may be a standards-based PoC application specifically, or an application based on the push-to-talk concepts of floor control and the like such as, for example, Push-to-Show. The email extensions expand the universe of people one can interact with beyond people who have new terminals or devices, and new services, such as people who have only email and/or SMS, for example. The email extensions provide the ability to send PoC messages which are primarily audio clips as attachments (in the case of email) or as pointers to a web location (when SMS is used). The email extensions provide an ability to close the loop, that is, responses such as, for example, typed, recorded, and attachments, are delivered back to the originating PoC user. The email extensions provide for mixed mode support wherein the participants may be any arbitrary mix of PoC, Email, and other types of users. The email extensions also provide for automatically creating a chat session in which all participants receive all exchanges irrespective of whether they are PoC or Email; in other words, a PoC session automatically shows all participants and “Reply All.”

Accordingly, yet another embodiment of the present invention is a method for an online Push to Talk over Cellular (“PoC”) subscriber to include non-PoC subscribers and offline PoC subscribers in a PoC exchange over a network. The method comprises identifying a participant in the PoC exchange as other than an online PoC subscriber; converting a PoC communication into a PoC message compatible with a platform used by the participant; and communicating the PoC message to the platform of the participant over the network. The method may further comprise communicating with the platform of the participant over the network to receive a response to the PoC message from the participant. The method may yet further comprise rendering the response for viewing by the PoC subscriber.

Yet another embodiment of the present invention is a PoC client for carrying out a PoC exchange over a network between PoC subscribers, non-PoC subscribers, and offline PoC subscribers. The PoC client comprises a plurality of stored program instructions for identifying a participant in the PoC exchange as other than an online PoC subscriber; converting a PoC communication into a PoC message compatible with a platform used by the participant; and communicating the PoC message to the platform of the participant over the network. The PoC client may further comprise stored program instructions for communicating with the platform of the participant over the network to receive a response to the PoC message from the participant. The PoC client may yet further comprise stored program instructions for rendering the response for viewing by the PoC subscriber. The PoC client may be a PoC client device such as PoC mobile phone, a PoC personal data assistant, or a PoC notebook computer, or may be a digital information storage medium.

### BRIEF DESCRIPTION OF THE SEVERAL VIEWS OF THE DRAWINGS

FIG. 1 is a flowchart showing an illustrative client-side PoC exchange for initiating a PoC call with a new group.

FIG. 2 is a schematic block diagram of a PoC client device.

FIG. 3 is a flowchart showing an illustrative technique for acquiring filler information from messages such as email and SMS.

FIG. 4 is an pictorial representation of a sequence of displays on a screen of a PoC device.

FIG. 5 is a pictorial representation of an exemplary promotion du jour.

FIG. 6 is a flowchart showing how active billboards may be processed by a client filler information display application.

FIG. 7 is a schematic diagram showing an example of one type of PoC client filler information acquisition application 206, namely an illustrative advertising engine.

FIGS. 8 and 9 are schematic diagrams showing an example of a powerful PoC system that incorporates the use of messaging to enhance PoC exchanges.

FIG. 10 is a functional block diagram showing one possible integration for Push to Email.

FIG. 11 is a flowchart showing part of an illustrative PoC session that handles the processing of incoming email messages and the rendering of their contents.

FIG. 12 is a pictorial representation of an exemplary contact list screen.

FIG. 13 is a pictorial representation of a Push to Show screen.

FIG. 14 is a schematic diagram of a streaming sampler system.

FIG. 15 is a schematic diagram showing an exemplary Push to Blog session.

FIG. 16 is a schematic diagram of a concierge and directory services system.

FIG. 17 is a pictorial representation of an exemplary contact list screen reflecting the integration of PoC with IM and PTS.

### DETAILED DESCRIPTION OF THE INVENTION, INCLUDING THE BEST MODE

As advanced cellular networks such as 3 G networks are being deployed by operators worldwide, various communications protocols are becoming increasingly popular on personal mobile devices that have communications connectivity over such networks, including cellular phones and cellular-enabled devices such as personal data assistants, laptop computers (including tablet computers), and gaming devices. One of the very popular communications protocols is Push to Talk over Cellular (“PoC”). These personal mobile devices are powered by processors of various types, including microprocessors, controllers, microcontrollers, and so forth, and may be provided with stored programs known as client applications to extend the services offered, including client applications to provide filler information for dead time intervals and to communicate PoC session content with non-PoC subscribers and with PoC subscribers who are offline. Through the use of one or more client applications to provide these extended services, the user experience is enriched and the operators' pricing flexibility is enhanced without need to modify the operating system or the network.

Presentation of Filler Information During PoC Exchange Delays

Many conditions can delay the completion of PoC exchanges, including long transit times that are routine in some systems, poor signal quality, temporary system delays due to heave traffic or network problems, heavy site traffic, and so forth. User-related factors such as normal response delay, engagement in other activities or other phone calls, user inattention, and other types of distractions may also contribute to delays in completing PoC exchanges. Delays like these, which result in “dead time” or “wait time,” are particularly prevalent at the initiation of PoC sessions that typically involve the use of SMS or other types of messaging to establish the session, during which the screen used to initiate the PoC exchange either remains statically displayed on the client, or simply goes blank or displays an incomplete screen relating to the PoC exchange, or displays a screensaver, or is otherwise not constructively communicating information. Advantageously, a client application is provided to display filler information in response to the occurrence of dead time. Initiation of the filler information display may occur in connection with the initiation of a function known to typically be associated with dead time, such as the process of establishing a PoC session by the use of invitations and acceptances, or upon detection of dead time lasting more than a particular length of time. Preferably, the static screen from which the PoC exchange is initiated, or the blank screen or other static screen, is replaced by a new screen which contains the filler information. While the user awaits normal communications, various types of filler information may be presented to the user for various purposes, such as to entertain or inform the user, or provide the user with various commercial opportunities.

Suitable filler information includes promotional material such as advertisements, entertainment schedules, news headlines, traffic advisories, and weather advisories, as well as personal information designated by the user. Promotional material also includes samples of music, video, ring tones, pictures, and the like, perhaps along with identifying and ordering information should the user wish to make a purchase. User personal information may include music, video, pictures, daily task or appointment reminder or list, and the like.

The filler information may be provided by external sources, from the user's internal files, or by other client applications. When provided by sources other than the user, the filler information may be provided free of charge, on a prepaid basis, on a pay-as-you-go basis, on a subscription basis, on a bartered bases, or in accordance with any desired compensation scheme.

In one approach, the filler information is displayed essentially only during the dead time. In another approach, the filler information is displayed for a minimum period or for a fixed period upon detection of the delay, whether direct or indirect as by initiation of an action likely to involve delay, even if the dead time terminates before the minimum or fixed period. In another approach, display of the filler information is stopped upon detection of termination of the dead time. In another approach, the user is alerted to termination of the dead time upon detection thereof, and if the user is in the process of interacting with the filler information, the user is given the option to save the status of the interaction and terminate the filler information display.

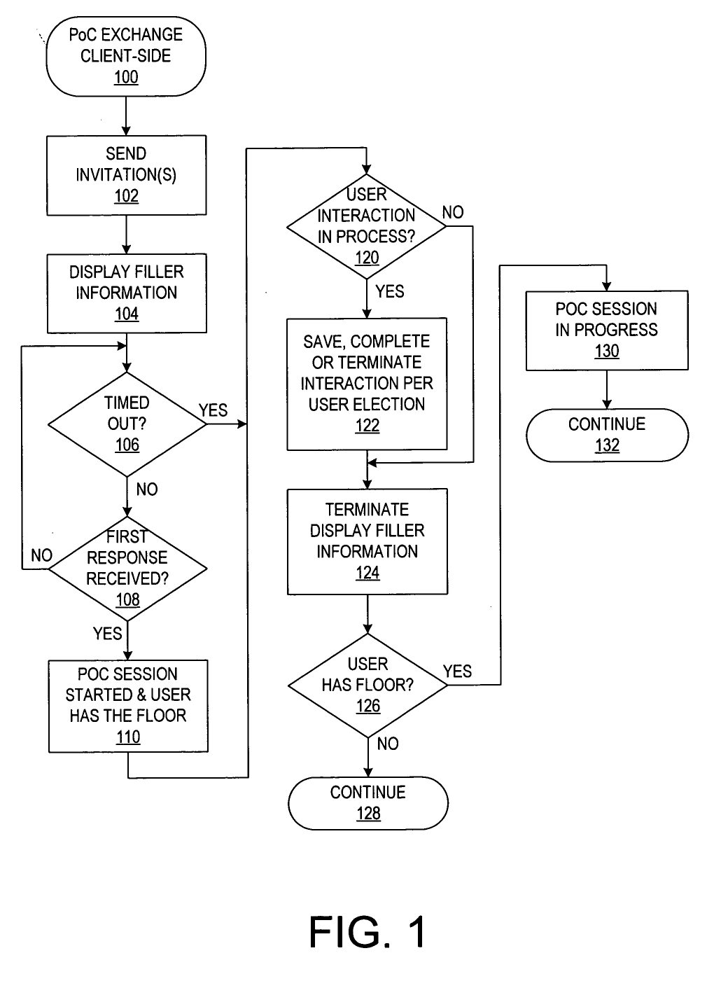

FIG. 1 is a flowchart showing an illustrative client-side PoC exchange 100 for initiating a PoC call with a new group. An invitation is sent to the member or members of the group (block 102) and filler information is displayed (block 104). Depending on the length of the dead time, one or more information screens may be displayed. When delays are lengthy, different information screens may be displayed sequentially during the lengthy delays. If a response is received before the open invitation period times out and while the filler information is being displayed and possibly being interacted with by the user (blocks 106/no and 108/yes), the PoC session is considered to have started and the initiating user is given the floor (block 110). When the open invitation period times out (block 106/yes) or a PoC session has started (block 110), a determination is made of whether the user is interacting with the filler information (block 120). If the user is interacting (block 120/yes), the user is given the option of saving the state of the interaction for later completion, or terminating or completing the interaction (block 122). When no user interaction is in process (block 120/no) or when an interaction has been saved, terminated or completed (block 122), the display of filler information is terminated (block 124). Termination may occur immediately or after the filler information has been displayed for a predetermined period of time. If the attempt to initiate a PoC session has failed as indicated by the initiating user not having the floor (block 126/no), processing may otherwise continue in a conventional fashion (block 128). However, if the initiating user has the floor (block 126/yes), the PoC session may be considered to be in progress (block 130). Processing continues in a conventional manner (block 132), and additional participants may join the PoC session if they accept their invitations.

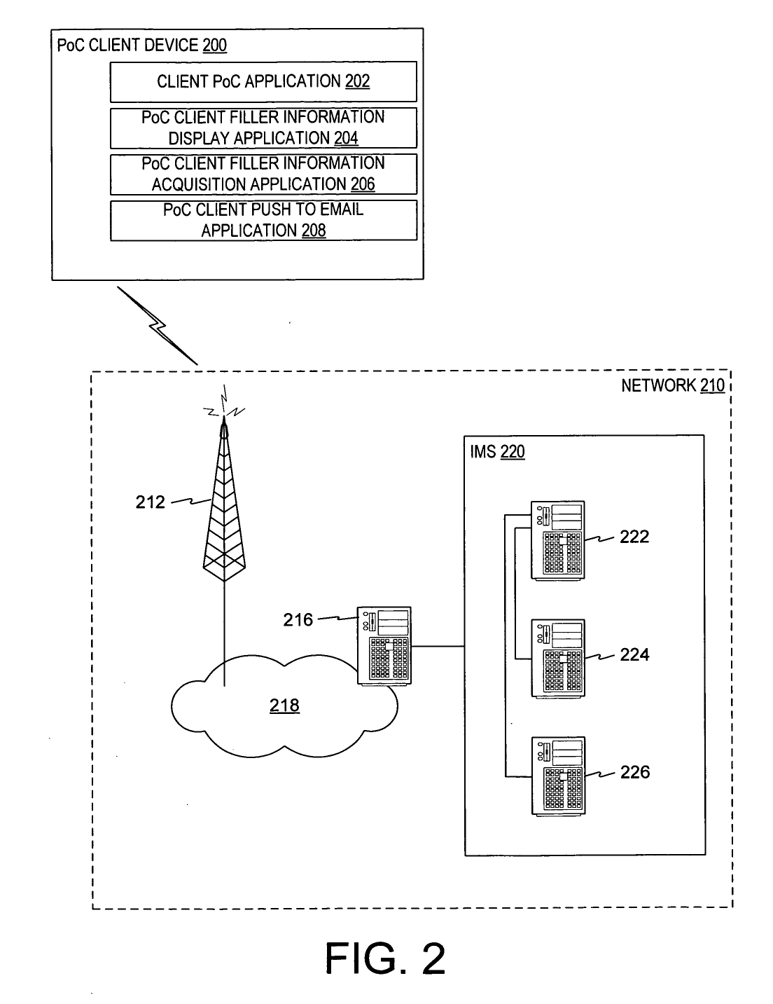

FIG. 2 is a schematic block diagram of a device 200 that incorporates a client PoC application 202 and a PoC client filler information display application 204. The PoC client device 200 has wireless connectivity to network 210 for PoC communications. Illustratively, the network 210 may have a standard Open Mobile Alliance (“OMA”) PoC network architecture of a type well known in the art, which is based on a PoC application server 224 connected within an IP Multimedia System (“IMS”) 220. The IMS 220 handles common functions such as user authentication, call routing and generic charging based on the Session Initiation Protocol (“SIP”). The PoC server 224 handles application-specific tasks such as floor control, and provide interfaces to the operator's provisioning and network management systems (not shown). Also connected within the IMS 220 is a shared group and list management server 222 for pre-defined groups, and a presence server 226. The IMS 220 communicates to a network 218 (illustratively a wireless network such as Enhanced General Packet Radio Services (“(E)GPRS”) or Universal Mobile Telecommunications System (“UMTS”)) through a gateway 216. The network 218 in turn is in communication with various networks, including wireless networks such as GSM, EDGE, 3G and WCDMA.

Filler information may also be displayed on the invitee's personal mobile device from the time of acceptance of the invitation. The filler information may be displayed until the PoC session begins, as indicated when the invitee is notified that the user initiating the PoC session is given the floor, or may be displayed for a fixed length of time or while the invitee is interacting with the filler information, during which the floor holder's conversation may be buffered. Alternatively, filler information may be displayed to the invitee upon receipt of the invitation, who may not accept the invitation until termination of the filler information display.

Advantageously, filler information may be delivered whether or not the PoC application is active. When the PoC application is active, information provided by those other than the user may be pushed during slow times as email or SMS messages, for example, and stored locally for later display. When the PoC application is not active, such as when the user is asleep or is otherwise occupied, other applications may be active and able to receive useful information (with or without requesting it) for later display to avoid dead time problems. Illustratively, email containing the information may be delivered independently even when the PoC application is not running. Preferably, the information is transported in by using a second application independent of the PoC application, such as, for example, an independent email, multimedia service, or instant messaging application that may run whether or not the PoC application is running.

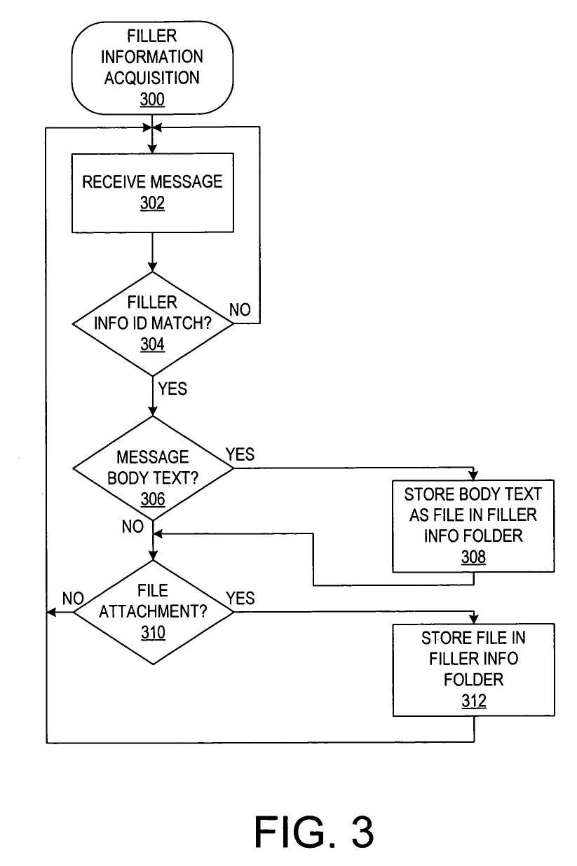

FIG. 3 is a flowchart showing an illustrative basic technique 300 for acquiring filler information from messages such as email and SMS. When a message is received (block 302), a determination is made of whether subject header information indicates filler information delivery (block 304). If so (block 304/yes), determinations are made of whether the message contains body text (block 306) and of whether a suitable file is attached (block 310). Any body text contained in the message is stored as a text file in a filler information folder (blocks 306/yes and 308). Any file attached to the message is also stored in the filler information folder (blocks 310/yes and 312). The files stored in the filler information folder may be subsequent access during dead times associated with a PoC exchange.

Preferably, the filler information screen includes an ability for the user to interact with it. While a variety of different types of mobile terminals or devices may be used, such as, for example, phones, smart phones, PDAs with communications capability, handheld and tablet computers with communications capability, and so forth, and while any user interaction technique suitable for the mobile terminal may be used, one effective technique is the use of a soft button or programmable hard button, which may be assigned various functions dynamically. Suitable types of buttons include bookmark, purchase, more information on the displayed subject matter, alternative information in the same genre as the displayed subject matter, and so forth. Other interaction techniques include voice, motion, menus, and so forth,

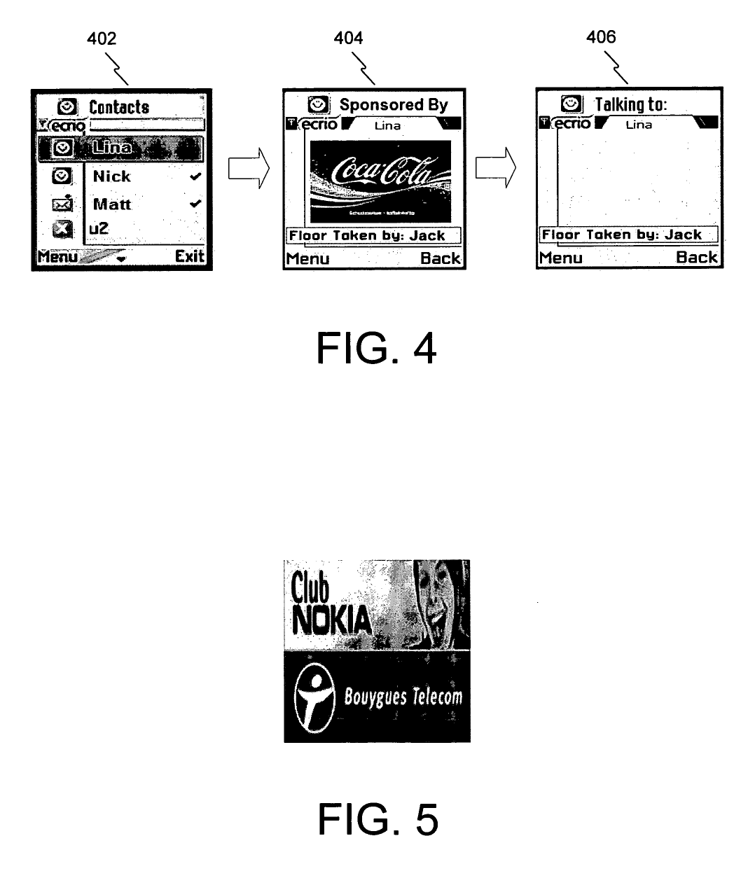

Advertisements are a particularly useful type of information to display in connection with dead time. FIG. 4 shows an example in which a PoC exchange is initiated from a contacts screen 402, the contacts screen 402 is replaced due to dead time by an advertisement 404 for Coca Cola® brand soft drink, and then the advertisement is replaced by a PoC screen 406 after the dead time is over.

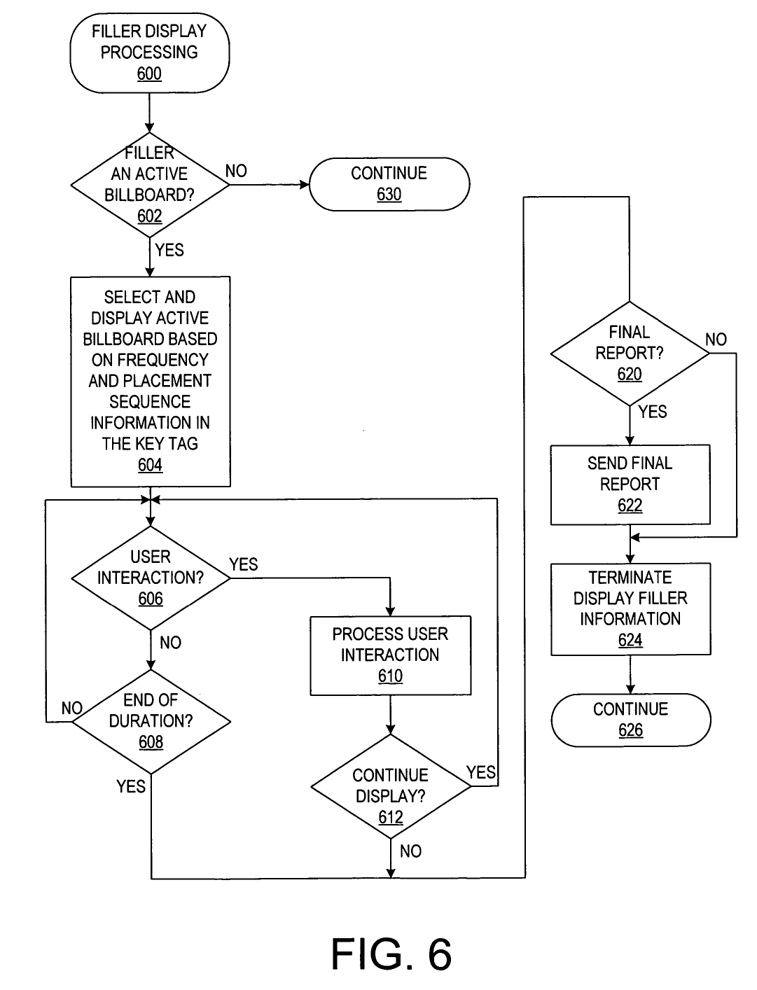

This solution provides an excellent venue for a carrier or service provider to present “promotions du jour” to their subscribers. An example of a promotion du jour for the Club Nokia™ program from Bouygues Telecom of Paris, Cedex, France is shown in FIG. 5.

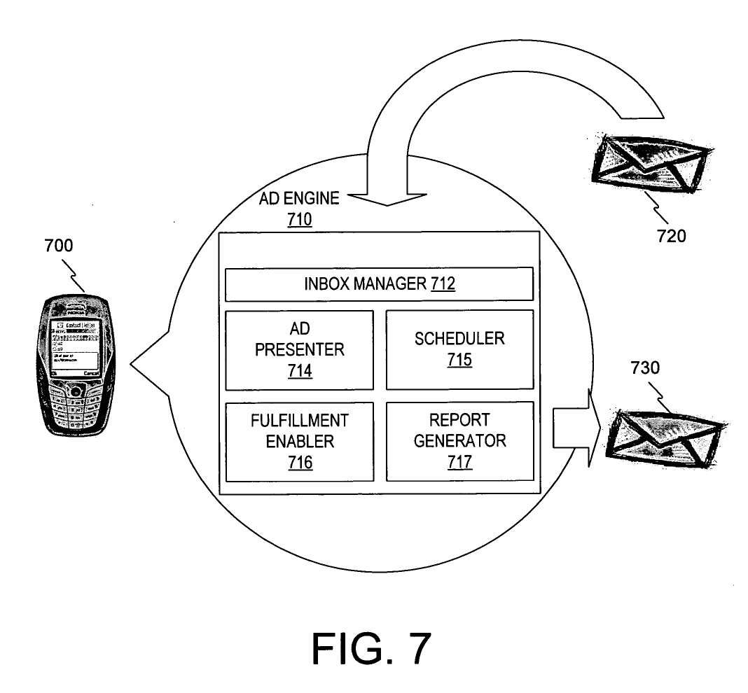

Advertisements may be presented as active billboards, which have the ability to display the advertisements, track responses, and enable fulfillment. These active billboard type of advertisements may be placed in PoC sessions as filler information in response to dead time to hold subscriber interest and potentially generate revenue. These active billboard type of advertisements may be delivered to the PoC Client in any suitable manner, including via email or other suitable technique such as an SMS-based scheme. An example 600 of how these active billboards may be processed by a client filler information display application such as the application 204 (FIG. 2) is shown in the flowchart of FIG. 6. If the filler information is an active billboard (block 602/yes), then the selection and display of a particular active billboard (block 604) is based on frequency and placement sequence data supplied in a “key tag.” Key tags may be used in the email forwarding the active billboard file to specify to the PoC client application the frequency, duration, placement sequence, and so forth of the advertisements. Key tags may be anywhere in the message. With respect to an email, for example, the key tag may be in the sender's ID, in the subject string, or in the body of the email itself. The PoC client may track and monitor subscriber response to the advertisement (blocks 606/yes and 610), including number of times displayed, any actions taken by the user in response to the ads, and so forth. The presented ads may be made “clickable” to allow for immediate action or deferred action. Examples of immediate action include an option to purchase a ringtone or, more generally, any good or service promoted in the advertisement. Deferred action includes the ability to “mark” items of interest for later review. Items requiring immediate action are processed immediately in the manner indicated by the user. Items that have been marked for later review may be saved as bookmarks to be presented at another opportune time, such as the next instance of opening the Web browser, at a later dead time, at a time specified by the user, and so forth. The presence of unseen items of interest may be flagged and brought to the attention of the user at a suitable point in the application, such as, for example, at the end of the current session or at the next launch of the application. If the user interaction is not of a nature to require termination of the active billboard (block 612/yes), such as requesting further information or responding to a question, the active billboard remains displayed and the process monitors for further user interaction (block 606) and for end of display duration (block 608). However, the user interaction may be of a nature to terminate the active billboard (block 612/no), such as selecting deferred action, completing a transaction, or manually terminating the advertisement. In this event, or when the active billboard on display has been displayed for the required duration (block 608/yes), a final report to the vendor or other interested third parties is issued if appropriate (blocks 620/yes and 622), display of the active billboard is terminated (block 624), and processing continues (block 626). Further processing may involve the display of more filler information or return to a PoC session.

With respect to the final report (block 622), email-based reporting may be used to measure ad effectiveness; optionally an SMS based scheme may be used. Advertisements may be placed by the network carrier based on agreements with sponsors or marketing organizations, or directly by the sponsors or the marketing organizations. Activity reports may be sent to the carrier for forwarding as appropriate, or may be sent directly to the sponsors or marketing organizations.

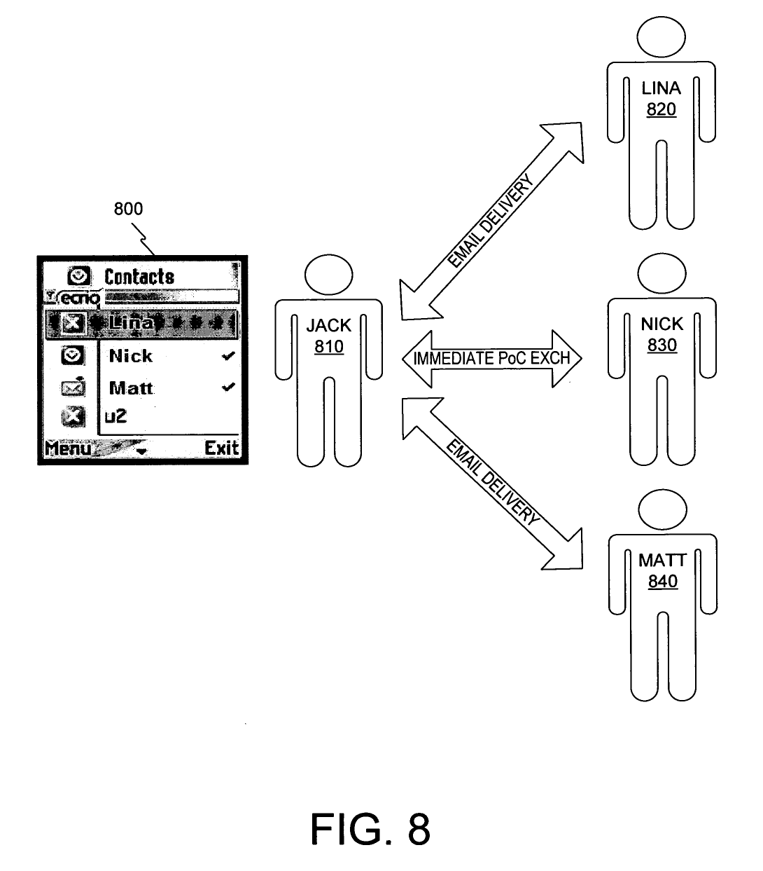

FIG. 7 shows an example of one type of PoC client filler information acquisition application 206, namely an illustrative advertising engine 710 that may reside on any suitable PoC client 700, such as, for example, an IMS-based PoC client. An incoming email 720 containing an advertisement is received by an inbox manager 712. A scheduler 715 selects ads for presentation based on any suitable criteria such as keytags, for example. The selected ads are presented one at a time by the ad presenter 714, and any responses to the ads are managed by the fulfillment enabler 716. Data is collected by a report generator 717, which either autonomously or upon command generates and sends an outgoing email 730 containing an ad activity report to an interested addressee.

While various implementations of an inbox manager are possible, an example of one possible implementation follows. To deliver an advertisement to the PoC client using email, an email is sent with the advertisement attached as a file to the email address of that user, with the following syntax in the email subject line: PoC advert. This will let the PoC client retrieve the attached file and store it for filler information during dead time such as when the user is to start a session. Note that the client may store any desired number of advertisements, illustratively twelve. The advertisements may be selected in any suitable manner. One selection technique is to randomly select one of the advertisements for display during dead time when a session is started. Another is to prioritize selection based on any desired criteria. The number of advertisements to be managed can be very easily changed by the appropriate configuration of the PoC client. Similarly the advertisement sponsor can also delete or recall an advert by sending suitable instructions, again via an email with appropriate key word or tag.

This example which uses a very simple, single key/tag value is simplified for clarity. The set of key/tags may be extended to cover things like (a) number of times to be displayed; (b) frequency of display; (c) duration of display; and so forth. A similar set of display statistics may be gathered to record (a) the number of times the ad was displayed; (b) the ads selected by user for follow through; (c) the actual followthrough time stamp; and so forth.

A particularly popular form of advertisement is the coupon. One type of coupon may be thought of as, for example, a form to be used as an order blank or for requesting information or obtaining a discount on merchandise. Following is an example of user interaction with a coupon during a PoC session, in accordance with the general principles described herein. Coupon interaction as described herein may be used in other types of communications sessions as well, including Push to Show.

Coupons, including those of the advertisement type, may be displayed in response to dead time. In FIG. 4, for example, the advertisement 404 that replaces the contacts screen during dead time at initiation of a PoC session might be one of a series of coupons that is displayed to fill the dead time. The user may interact with the coupons in any number of ways, such as by deferring action by book marking coupons or saving coupons to a folder or folders, initiating a present transaction using a coupon of immediate interest, and discarding coupons of no interest.

A present transaction may be initiated in any convenient manner, such as, for example, by tapping on the coupon with a stylus, navigating a cursor over the coupon and clicking it, pressing a soft key defined for the purpose of selecting the coupon, selecting using a key from a keypad, or other definable user action. Examples of immediate action include presenting the coupon for redemption in order to receive a discount or other incentive in connection with a purchase that is in process or that is being contemplated.

Coupons deferred by having been bookmarked or saved to folders or in any other way may be retrieved later for viewing and possible action either manually or automatically. A user may save a coupon with an indication of whether the coupon should be saved for later access by the user, or automatically presented again to the user such as at a scheduled time, upon the occurrence of a defined event (such as when a user is near a store that will redeem the coupon), or during dead time. An example of manual retrieval is when the user expressly wishes to review the saved coupons, as when preparing for a shopping trip or when browsing at a store. An example of automatic retrieval is during dead time, when the saved coupons may automatically be displayed to the user for further user action. Another example of automatic retrieval is when the user is in proximity to or present at a place where a coupon may be redeemed, which may be determined using well known GPS and cell triangulation techniques, or by the user merely identifying with a data input device the name or other identifier of the place where the user is.

PoC Email

The PoC client device 200 may also include a PoC Client Push to Email Application 208 (FIG. 2).

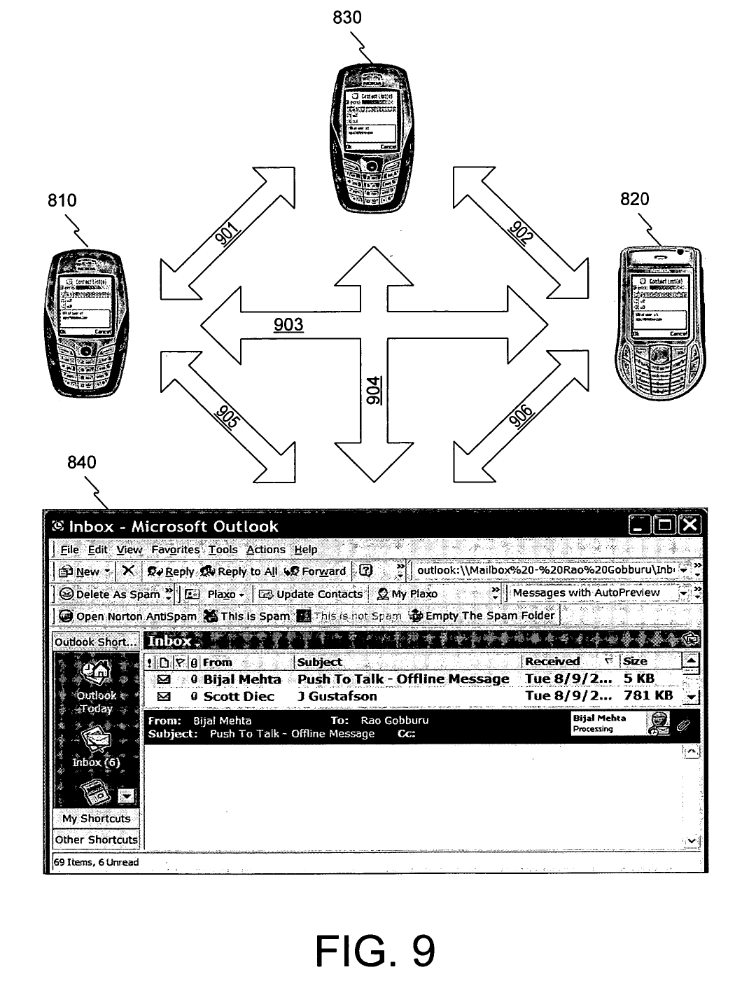

FIG. 8 and FIG. 9 show an example of a powerful PoC system that incorporates the use of messaging such as email and also SMS if desired to enhance PoC exchanges. Email in particular is inherently wide and big and greatly enhances the data exchange capability of PoC. As shown in FIG. 8, Jack 810 is a PoC subscriber who uses an IMS based PoC client and is online with his contact list 800. Nick 830 is also a PoC subscriber who uses an IMS based PoC client and is also online. Lina 820 is also a PoC subscriber who uses an IMS based PoC client, but Lina 820 is offline. Matt 840 is not a PoC subscriber, and uses a browser running on any suitable platform such as a standard personal computer or a personal data assistant (“PDA”). Jack 810 initiates a PoC exchange with Lina 820, Nick 830, and Matt 840, and speaks a message into his device. Since Nick 830 is a PoC subscriber and is online, he gets Jack's voice message as live talk, and can engage in a live talk exchange with Jack 810. Although Lina 820 is also a PoC subscriber, she is not online. However, advantageously Lina receives Jack's voice message as an attachment to an email delivered to her inbox. Although Matt 840 is not even a PoC subscriber, advantageously he too receives Jack's voice message as an attachment to an email delivered to his inbox.

Since Lina 820 and Matt 840 are not online, they can read their emails and respond later by email when they do go online. While Nick 830 can respond immediately by voice to Jack's voice message because he is online and is a PoC subscriber, he can also respond with an email message, either in addition to or in lieu of a voice response. Emails allow enormous flexibility in the type of information that can be delivered, including such information as greeting cards, maps, graphics of any sort, video, audio, and so forth. The format of the email attachment is detected by the email-enchanced PoC client so that it can be appropriately rendered.

It is possible for Lina 820 and Matt 840 to become aware of Jack's session and to provide responses during Jack's session. Since Matt 840 is not a PoC subscriber, his voice responses are sent by email as attachments to be suitably rendered by Jack's client. In Lina's case, she can join Jack's session, in which case her responses are processed as an immediate PoC exchange.

In summary and as shown in FIG. 9 by communication paths 901-906, email-enhanced PoC extends the reach of PoC and embraces new platforms and participants, including offline subscribers as well as non-subscribers.

The rendering of email by a PoC client may be performed as follows. To send a message to the PoC user using email, for example, send an email to the email address of that user with the following illustrative syntax in the email subject line: PoC message. Note that the syntax is case sensitive. This will signal the PoC client to display the text body of the email if the text is clear text, although other implementations may use HTML-text or other formats if desired. If a file is attached to the email, then the PoC client displays the file to the user for viewing using the native application that supports the file format; for example, the image viewer for a jpg-file. To view this file, the user selects “Attach.” Suitable file types include text, pictures, video clips, audio files, and so forth.

If desired, the user may be provided with the capability of specifying when to render attachments. In this event, Jack 810 could specify that any audio email attachments be rendered immediately, which would allow an audio exchange to occur between Jack 810 and Matt 840, albeit with pauses from Matt to Jack. Additional user control may be provided, such as specifying different times for rendering based on originator, type of attachment, size of attachment, priority designation, and so forth.

Advantageously, Push to Email may be provided as a client-only solution that works with standard PoC servers. Push to Email extends the reach of a PoC subscriber to include offline PoC subscribers as well as non PoC subscribers via Email. Push to Email provides for closing the loop, in that responses are delivered back to the originator from all parties, including non-PoC subscribers. The client may also be unified in that responses may be read or played or viewed or stored as appropriate in the PoC Client. The recipient is informed of attachments that are too large to be effectively handled by the Push to Email client or that are of unknown file type, and such files are stored so that the recipient may access them at the recipient's convenience by other means.

Advantageously, the email responses may be threaded. When an Email is received at the phone inbox, it is inspected by the Push to Email client to determine which if any thread it belongs to. If the Email is threaded, it is taken out of the phone inbox and presented to the recipient within the proper context.

The Push to Email client may also be used to provide “smart voicemail” capability. In conventional voicemail, the caller dials a number and the call is answered by the voicemail system if the person being called is not available. The voicemail system presents a greeting message, and the caller is invited to leave a message for the person being called. Smart voicemail differs from conventional voicemail in that the caller may select, with the Push to Email, various options to direct how the call should be handled by the recipient's client, before the call is made. The caller may, for example, direct that the call be placed directly into the recipient's “voicemail” or email system, thereby not requiring that the recipient be alerted about the call when it is made.

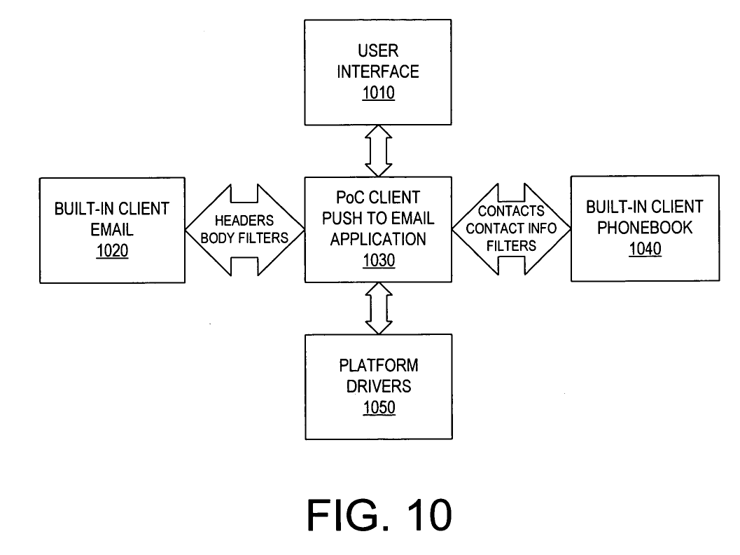

FIG. 10 shows one possible implementation of Push to Email. The illustrative Push to Email Application 1030 is horizontally integrated with local Email and Phonebook functionalities 1020 and 1040 respectively, which are both built into the mobile terminal. The Email functionality 1020 and the Push to Email application 1030 communicate through headers and body filters, while the Phonebook functionality 1040 and the Push to Email application 1030 communicate through contacts and contact information filters. Platform drivers 1050 and a user interface 1020 are included.

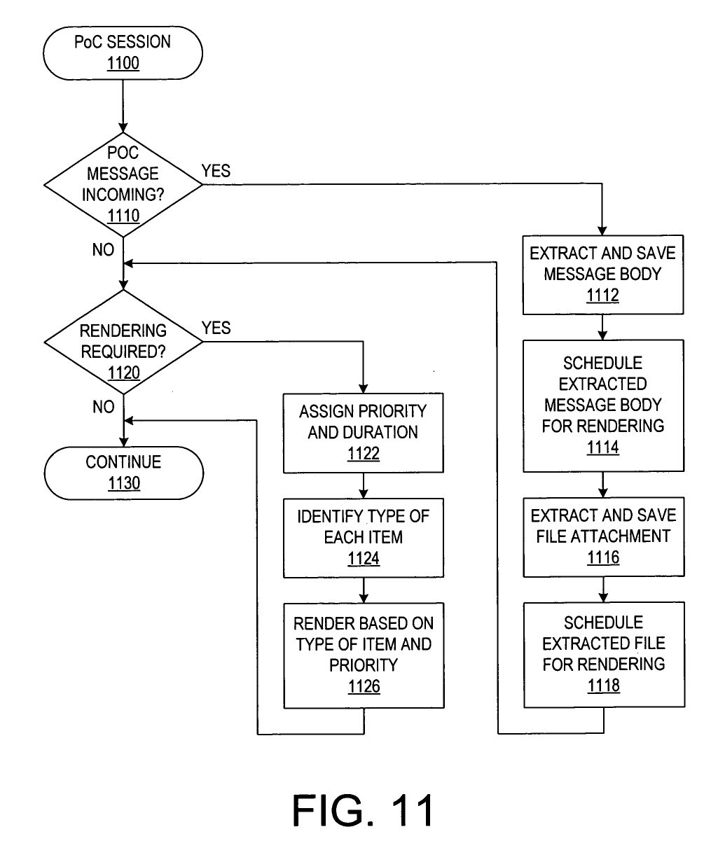

FIG. 11 is a flowchart succinctly showing part of an illustrative PoC session 1100 that handles the processing of incoming PoC messages such as pushed email and SMS, and the rendering of their contents. If an incoming PoC message is detected (block 1110/yes), the body of the message is extracted and saved in a database file (block 1112), and its rendering is scheduled (block 1114) based on a number of factors such as may be contained in a key tag in the message, as specified by the user, and by default. If the incoming PoC message has a file attachment, the file is extracted and saved in a database file (block 1116), and its rendering is scheduled (block 1118) based on a number of factors such as may be contained in a key tag in the message, as specified by the user, and by default. Scheduling may be immediate or at a later time during or outside of the PoC session. The process 1100 then checks if any rendering is required at the moment (block 1120). If one or more items require rendering (block 1120/yes), a determination is made of the rendering order and of the duration of each of the renderings (block 1122). The types of the items presently requiring rendering is also determined (block 1124), so that appropriate application may be evoked for the rendering. The items presently requiring rendering are then rendered based on the item type and priority (block 1126).

Push to Show

Push To Show (“PTS”) is the next step after PoC in the evolution of the “Push To X” services. An IMS-based Push to Show (“PTS”) client may provide for multiple exchanges of video streaming along with other functionality such as instant messaging (“IM”), presence and location, and content, including pre-created files such as, for example, MS Word, MS Excel, MS PowerPoint, audio clips, images, video clips, and the like. Push To Show may essentially be a client only solution that replaces the audio stream in a PoC implementation with video media. In the client-only implementation of the application, advantageously the PoC server does not need any changes. In this case, all other aspects of a PoC implementation such as Contact List/Group Management, Session Setup/Teardown, and Floor Control, and so forth may remain the same. Push to Show may be implemented as one of multiple applications on an IMS client framework, which may include IM, Presence and Location, Content, and Video Share. Compared with video share, for example, Push to Show provides voice and video over IP, while Video Share provides voice over the circuit switch while providing video over IP.

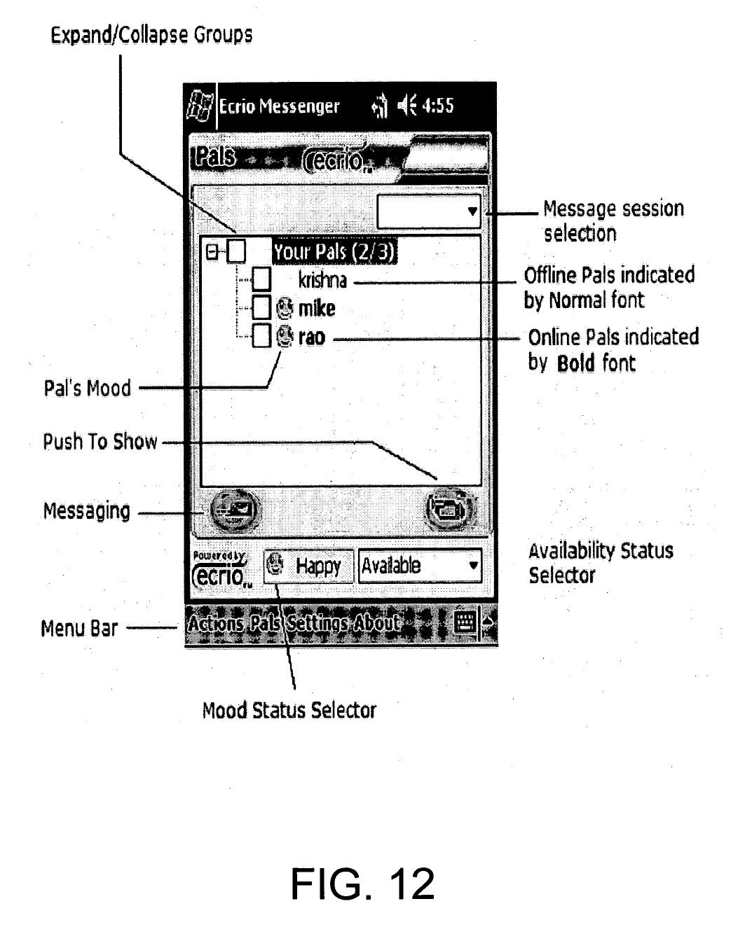

FIG. 12 shows an example of a contact list screen that includes a Push to Show soft key. The “Your Pals (2/3)” group is displayed in an expanded state, showing the Pals and the mood of the Pals. Pal krishna is offline, as indicated by normal font. Pals mike and rao are online, as indicated by the bold font. In addition to the Push to Show soft key, a Messaging soft key also is displayed.

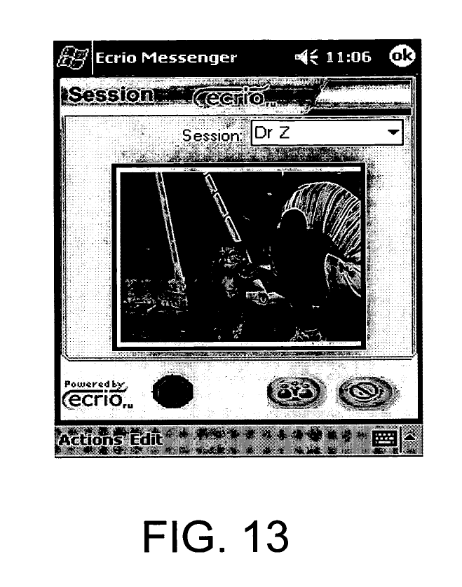

FIG. 13 shows an example of an image that is being displayed during a Push to Show session. The image may be any desired image, including a still picture, a prerecorded video, video feed from a camera, a coupon or other advertisement, and so forth.

PTS sessions are a particularly powerful tool for reaching members of informal affinity groups with coupons and other types of advertisement. One common type of informal affinity group is friends who may be geographically dispersed yet routinely keep in touch using PoC. Since the friends are geographically dispersed, they may likely see different coupons during dead times in their PoC sessions. However, since the friends have a good sense of what interests one another, one friend might see a coupon during dead time that he knows would be of interest to another friend, and can send that coupon to another friend using the PTS capability. The friend receiving coupons from other friends can take any action he desires, such as, for example, deferring action by book marking coupons or saving coupons to a folder or folders, initiating a present transaction using a coupon of immediate interest, and discarding coupons of no interest.

PTS may also be used to transfer other “documents” such as, for example, individual event tickets, as well as coupon books and season passes. Moreover, a multiple-use coupon or ticket such as a seasons pass may be transferred for just one use or a limited number of uses as defined by the initial holder, after which it reverts back to the initial holder. An example of a season pass would be a seasons baseball pass. The initial holder of the season baseball pass may be engaged in a PoC session with other baseball fans, and may decide to transfer the season pass to one of the other fans for one or more specified games, or for the duration of the season. The selection may be made using soft keys, keypad entry, or other type of input device, and the season pass may be transferred in a PTS session. The recipient may use the season pass to enter the game or games in any convenient manner, such as by light communication using bar code information, and the use of the season pass may be limited to the prescribed number of uses and each use may be allocated and accounted for using techniques such as those described in U.S. Pat. No. 6,736,322, issued May 18, 2004 to Gobburu et al. and entitled “Method and apparatus for acquiring, maintaining, and using information to be communicated in bar code form with a mobile communications device,” which hereby is incorporated herein in its entirety by reference thereto. Techniques for light communication using bar code information are also described in U. S. Pat. No. 6,685,093 issued Feb. 3, 2004 to Challa et al. and entitled “System, method and apparatus for communicating information between a mobile communications device and a bar code reader,” which hereby is incorporated herein in its entirety by reference thereto.

Streaming Sampler

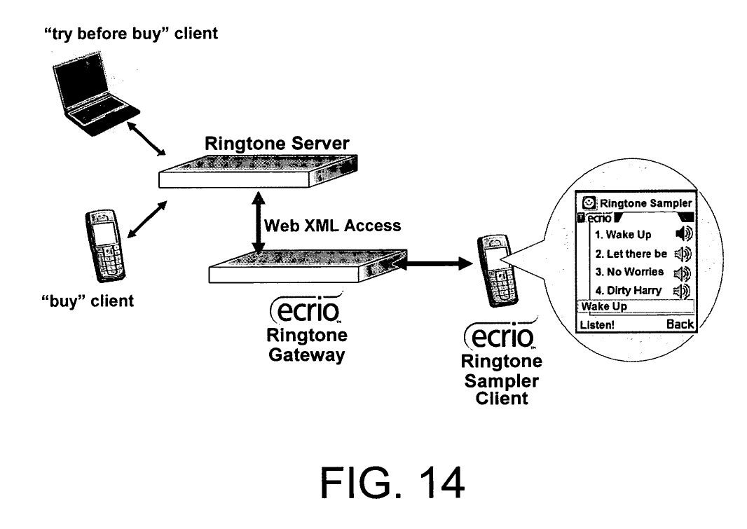

One motivation for a streaming sampler is to enable “try before you buy” on mobile phones for various products such as ringtones, screensavers, and so forth. No change to standard 3 G network infrastructure is required for the streaming sampler. FIG. 14 shows an illustrative initial configuration in which a ringtone sampler client, illustratively a J2ME client, works in tandem with a ringtone, screensaver, or other streamable product gateway. The J2ME client is capable of playing ringtones, screensaver, and other stream samples. The Gateway accepts ringtone sample in native format and streams to the client. The streaming sampler preserves DRM guidelines for content. The streaming sampler is an easily accessible client reachable from the home screen. The J2ME client gives widest reach. The streaming sampler is extensible to cover AudioNideo content.

Push to Blog

The Push to Blog capability enables “personal journal,” reports, and other such content to be published from mobile phones to individuals and blog sites. A simple authoring tool allows the user to publish audio and video content if the mobile phone includes a camera. The blogger is connect live to online communities, and may reach offline communities through popular blog sites for time shifted viewing.

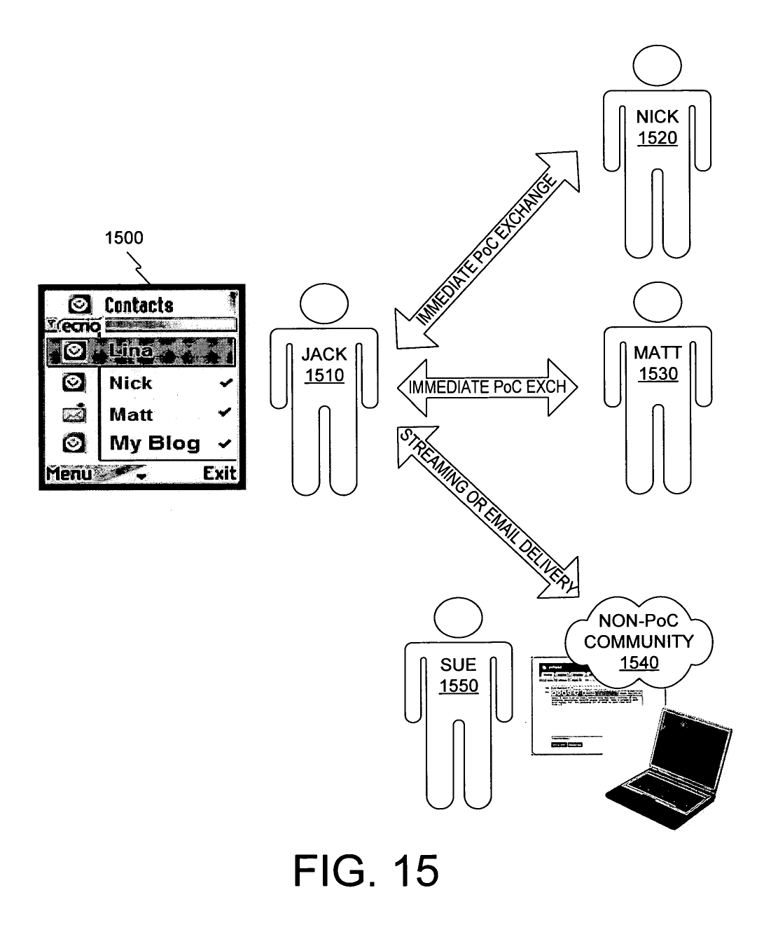

FIG. 15 shows an example of a Push to Blog session in which Jack 1510, an online PoC subscriber, is creating a journal entry. The journal entry is communicated immediately to Nick 1520 and Matt 1530, who are both online PoC subscribers. Jack's journal entry is communicated to the non-PoC and offline communities 1540, including Sue 1550 who is not a PoC subscriber, as a blog. Jack's client generates the blog and delivers the blog to the non-PoC and offline communities in any suitable manner, such as in real time using a streaming internet protocol, or by messaging such as email.

Concierge and Directory Services

A PoC client may be operational across multiple platforms including mobile phones, PDAs and PCs. It may allow for rich communication, in that support may be extended beyond PoC to include IM, Images, Video Clips, and so forth. This capability is useful for live multi-modal communications with concierge and directory services, and creates upsell opportunities for “sponsored links.”

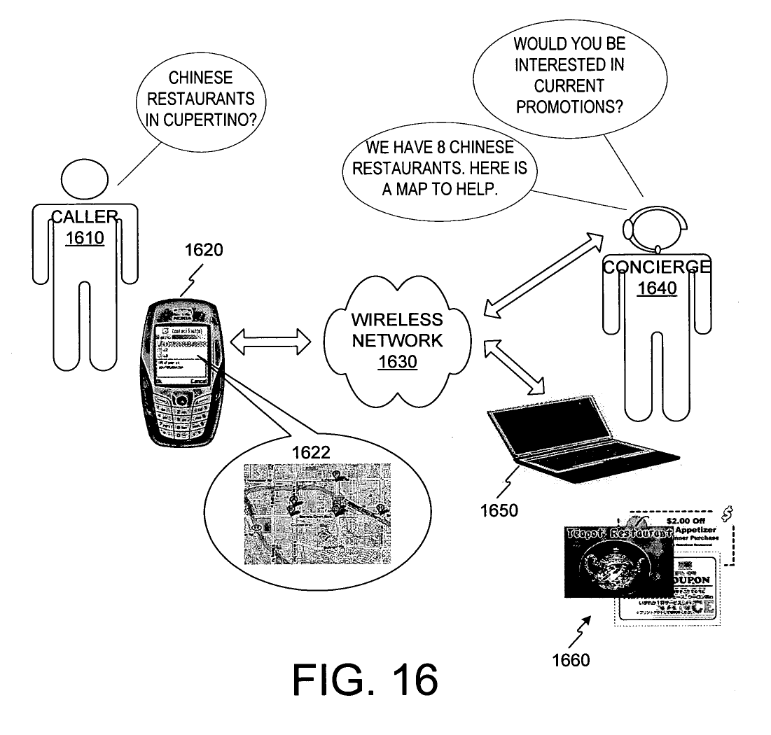

FIG. 16 shows an example in which a caller 1610 asks for Chinese restaurants in Cupertino in a PoC session using a PoC client device 1620 over a network 1630. A concierge 1640 responds by explaining that there are eight Chinese restaurants in the area, sends a map 1622 to the caller 1610 for display on the caller's PoC client device 1620, and offers promotional coupons 1660 to the caller 1610. The coupons 1660 are an upsell opportunity for the restaurants and other businesses, which may be nearby or which may offer goods and services related to Chinese food, dining, and so forth. The coupons 1660 may be forwarded electronically by the concierge using the computer 1650.

Suitable Platforms and Software

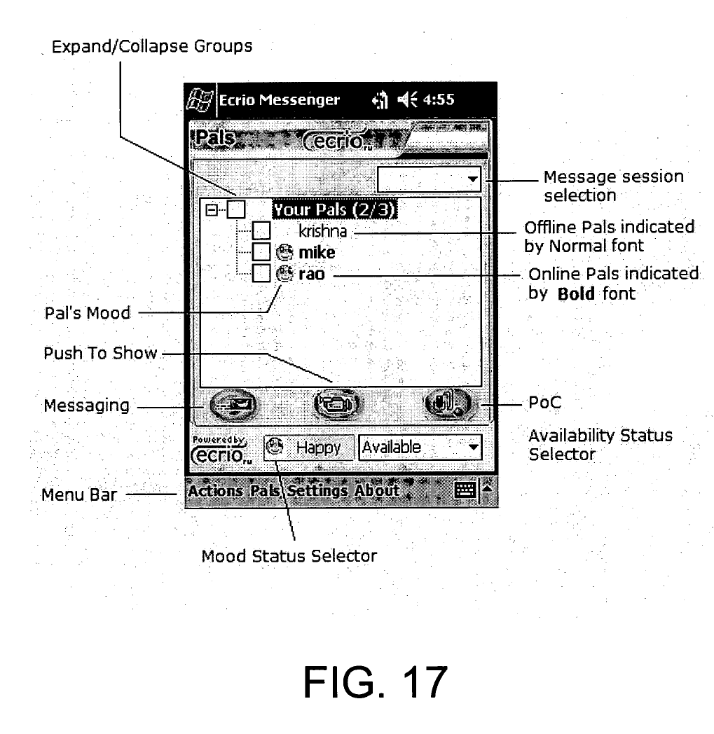

FIG. 17 shows an example of a contact list screen reflecting the integration of PoC with IM and PTS. The “Your Pals (2/3)” group is displayed in an expanded state, showing the Pals and the mood of the Pals. Pal krishna is offline, as indicated by normal font. Pals mike and rao are online, as indicated by the bold font. An Availability Status Selector and Mood Status Selector controls are provided. The screen includes Messaging, Push to Show, and PoC soft keys.

The basic functionality for implementing the new applications described herein is well known in the art, being described in publications and commercially available. OMA PoC client extended functionality is described in, for example, the OMA PoC Client Extended Functionality Manual, 2006, which is available from Ecrio Inc. of Cupertino, Calif., USA. An earlier standard, the NEMS (“Nokia, Ericsson, Motorola, Siemens”) standard, was introduced prior to the present OMA standard and has been incorporated therein. The NEMS PoC client extended functionality is described in, for example, the NEMS PoC Client Extended Functionality Manual, 2005, 2006, which is available from Ecrio Inc. of Cupertino, Calif., USA. The NEMS PoC client Email loop is described in the NEMS PoC Client Email Loop User Manual for the Nokia 6630, 2006, which is available from Ecrio Inc. of Cupertino, Calif., USA.

OMA IMPS Handset Software for clients and Client Software that are fully standards compliant and ready for immediate release to terminal manufacturers, OEMs, ODMs and mobile operators are available from Ecrio Inc. of Cupertino, Calif., USA. The Ecrio OMA IMPS Handset software consists of fully functional clients and a development suite comprising the Toolkit & Library. Mobile terminal manufacturers may choose to either obtain completed clients from Ecrio Inc. of Cupertino, Calif., or choose to develop their own based upon Ecrio's OMA IMPS Toolkit & Library. The clients are customizable: task flow, user interface, and branding. Ecrio can optimize the software according to resident device OS, memory, general peripherals, user interface, and language requirements. The Ecrio IMPS Handset Software clients are available for feature phones, smart phones and wireless personal digital assistants. They are available either as embedded C clients or as downloadable J2ME™ clients. The embedded C clients are available on native OS, Symbian OS, Pocket PC, Smartphone and Palm OS® operating systems. Ecrio clients are pre-integrated and tested with feature phone platforms such as APOXI™, OMAP™, BREW™, etc. to speed up time-to-market. Additional information on Ecrio IMPS products is provided in a product specification entitled Ecrio IMPS Handset Software, No. IMPS-0511, 2005, 2006, which is available from Ecrio Inc. of Cupertino, Calif., USA, and which is incorporated herein in its entirety by reference thereto.

Push To Talk over Cellular (PoC) Handset Software that enables OEMs, ODMs and terminal vendors to deploy mass-market handsets with OMA PoC 1.0 or Consortium PoC (previously known as NEMS PoC) standards compliant Push-to-Talk solution is available from Ecrio Inc. of Cupertino, Calif. The Ecrio PoC software supports contact & group management, privacy, session management and optimal voice exchange for one-on-one as well as group communications. In addition, it offers seamless integration with Ecrio's proven and robust IMPS solutions to enhance the PoC user experience: Presence, Availability and Mood status are displayed on the phone screen. Talk Burst Control (Floor control), Do-not-Disturb, as well as support for a special push button and a speakerphone are provided. The Ecrio PoC Handset Software is available for feature phones, smart phones and wireless personal digital assistants. The Software, written in ANSI C is offered on native OS, Symbian OS, Pocket PC, Smartphone and Palm OS® operating systems. The Ecrio PoC Software is pre-integrated and tested with feature phone platforms such as APOXI™, OMAP™, BREW™, etc. to speed up time-to-market. Additional information on Ecrio PoC products is provided in a product specification entitled Ecrio PoC Engine Software, No. PoC-0511, 2005, 2006, which is available from Ecrio Inc. of Cupertino, Calif., USA, and which is incorporated herein in its entirety by reference thereto.

Residing on the networks of Service Providers, the IP Multimedia Subsystem (IMS) is an enabling platform for the deployment of advanced services including Push-to-Talk over Cellular (“PoC”), Instant Messaging and Presence Services (“IMPS”), and other 3 G services. A versatile handset IMS SDK for OEMs and ODMs which allows them to develop and deploy value added services is available from Ecrio Inc. of Cupertino, Calif. Optimized for mobile terminals with stringent resource demands, the Ecrio IMS Client software consists of a versatile IMS client SDK and a suite of IMS applications. The IMS Client SDK includes a 3 GPP R5/R6 IMS compliant library and an IMS Client Toolkit. The library supports signaling and media components. The toolkit hides all the complexities of the IMS standard and helps the developer to easily build applications. Ecrio also offers on various handsets, a suite of IMS compliant applications including IM, PoC, Video Messaging and Live Conferencing. The Ecrio IMS Handset Software is available for feature phones, smart phones and wireless personal digital assistants. The Software, written in ANSI C is offered on native OS, Symbian OS, Pocket PC, Smartphone and Palm OS® operating systems. The Ecrio IMS Software is also pre-integrated and tested with feature phone platforms such as APOXI™, OMAP™, BREW™, etc. to speed up the development of IMS compliant applications. The Ecrio IMS software is fully compliant with the 3 GPP IMS specifications and interoperable with (all) IMS compliant network deployments. A highly modular architecture with Open APIs allows the Ecrio IMS software to be tailored to the phone resources achieving a small footprint and allowing easy extensions for new value added service such as Audio or Video conferencing. Additional information on Ecrio IMS products is provided in a product specification entitled Ecrio IMS Client Framework Software, No. PoC-0511, 2005, 2006, which is available from Ecrio Inc. of Cupertino, Calif., USA, and which is incorporated herein in its entirety by reference thereto.

In addition to other approaches, the new applications may be delivered on the IP based Multimedia System (“IMS”) framework with Session Initiation Protocol (“SIP”) signaling. In order to provide an efficient and seamless interaction among these new services, 3 G mobile phones may use a resident IMS Client Framework product such as the Ecrio IMS product that supports a single application or multiple applications, and that is highly complete, optimized, interoperable, and tailored to limited resource terminals.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A method of using dead time arising from a communications exchange over a network, comprising:
acquiring filler information;
identifying a dead time interval relating to communications over the network; and
displaying the filler information at least during a part of the dead time interval.

2. The method of claim 1 wherein the communications exchange is a Push to Talk over Cellular (“PoC”) exchange, a Push to Show exchange, or a Video Share exchange.

3. The method of claim 1 wherein the communications exchange is a Push to Talk over Cellular (“PoC”) exchange.

4. The method of claim 3 wherein the displaying step comprises displaying the filler information during at least a major part of the dead time interval.

5. The method of claim 3 wherein the displaying step comprises displaying the filler information beyond termination of the dead time interval.

6. The method of claim 3 wherein the dead time interval identifying step comprises directly detecting an occurrence of the dead time interval.

7. The method of claim 3 wherein the dead time interval identifying step comprises identifying initiation of an event likely to involve the dead time interval.

8. The method of claim 7 wherein the event identifying step comprises identifying an action by a user to initiate a PoC session.

9. The method of claim 8 wherein:
the user action identifying step comprises identifying a sending of a set of one or more invitations to one or more prospective participants in the PoC session; and
the filler information displaying step comprises starting display of the filler information upon completion of a user command to send the invitation set.

10. The method of claim 9 wherein the filler information displaying step further comprises terminating display of the filler information after a predetermined time interval.

11. The method of claim 9 wherein the filler information displaying step further comprises terminating display of the filler information at initiation of the PoC session.

12. The method of claim 9 wherein the filler information displaying step further comprises terminating display of the filler information after initiation of the PoC session.

13. The method of claim 9 further comprising:
detecting user interaction with the filler information;
wherein the filler information displaying step further comprises terminating display of the filler information after completion of the user interaction.

14. The method of claim 3 further comprising:
detecting user interaction with the filler information;
wherein the filler information displaying step comprises terminating display of the filler information after completion of the user interaction.

15. The method of claim 3 wherein the filler information comprises an advertisement, further comprising:
detecting user interaction with the advertisement;
acquiring interaction information pertaining to the user interaction with the advertisement; and
reporting the interaction information to a server.

16. The method of claim 3 wherein the filler information acquiring step comprises acquiring the filler information from an email message body, an email message attachment, a SMS text, or a multimedia message.

17. The method of claim 3 wherein:
the filler information comprises a plurality of information items;
the filler information acquiring step comprises acquiring key tag information for each of the information items; and
the displaying step comprises displaying the information items in a sequence and for respective durations in accordance with key tag information.

18. A communications client for carrying out a communications exchange over a network, the communications client comprising a plurality of stored program instructions for:
acquiring filler information;
identifying a dead time interval relating to communications over the network; and
displaying the filler information at least during a part of the dead time interval.

19. The communications client of claim 18 wherein:
the communications exchange is a Push to Talk over Cellular (“PoC”) exchange; and
the dead time interval relates to PoC communications over the network.

20. The communications client of claim 19 wherein the dead time interval identifying instructions comprise stored program instructions for directly detecting an occurrence of the dead time interval.

21. The communications client of claim 19 wherein the dead time interval identifying instructions comprise stored program instructions for identifying initiation of an event likely to involve the dead time interval.

22. The communications client of claim 21 wherein the event identifying instructions comprise stored program instructions for identifying an action by a user to initiate a PoC session.

23. The communications client of claim 22 wherein:
the user action identifying instructions comprise stored program instructions for identifying a sending of a set of one or more invitations to one or more prospective participants in the PoC session; and
the filler information displaying instructions comprise stored program instructions for starting display of the filler information upon completion of a user command to send the invitation set.

24. The communications client of claim 23 wherein the filler information displaying instructions comprise stored program instructions for terminating display of the filler information after a predetermined time interval.

25. The communications client of claim 23 wherein the filler information displaying instructions comprise stored program instructions for terminating display of the filler information at initiation of the PoC session.

26. The communications client of claim 23 wherein the filler information displaying instructions comprise stored program instructions for terminating display of the filler information after initiation of the PoC session.

27. The communications client of claim 23 further comprising a plurality of stored program instructions for:
detecting user interaction with the filler information;
wherein the filler information displaying instructions further comprise stored program instructions for terminating display of the filler information after completion of the user interaction.

28. The communications client of claim 19 further comprising a plurality of stored program instructions for:
detecting user interaction with the filler information;
wherein the filler information displaying instructions further comprise stored program instructions for terminating display of the filler information after completion of the user interaction.

29. The communications client of claim 19 wherein the filler information comprises an advertisement, further comprising a plurality of stored program instructions for:
detecting user interaction with the advertisement;
acquiring interaction information pertaining to the user interaction with the advertisement; and
reporting the interaction information to a server.

30. The communications client of claim 19 wherein the filler information acquiring instructions comprise stored program instructions for acquiring the filler information from an email message body, an email message attachment, a SMS text, or a multimedia message.

31. The communications client of claim 19 wherein:
the filler information comprises a plurality of information items;
the filler information acquiring instructions comprise stored program instructions for acquiring key tag information for each of the information items; and
the displaying instructions comprise stored program instructions for displaying the information items in a sequence and for respective durations in accordance with key tag information.

32. The communications client of claim 19 wherein the communications client is a PoC mobile phone, a PoC personal data assistant, or a PoC notebook computer, the stored program instructions being stored thereon as a client application.

33. The communications client of claim 19 wherein the communications client is a digital information storage medium, the stored program instructions being stored thereon as a client application.

34. A method for an online Push to Talk over Cellular (“PoC”) subscriber to include non-PoC subscribers and offline PoC subscribers in a PoC exchange over a network, comprising:
identifying a participant in the PoC exchange as other than an online PoC subscriber;
converting a PoC communication into a PoC message compatible with a platform used by the participant; and
communicating the PoC message to the platform of the participant over the network.

35. The method of claim 34 further comprising communicating with the platform of the participant over the network to receive a response to the PoC message from the participant.

36. The method of claim 35 wherein the response is a pushed, pulled, or linked file.

37. The method of claim 35 further comprising rendering the response for viewing by the PoC subscriber.

38. The method of claim 37 wherein the response is an audio, video or image file.

39. The method of claim 34 wherein the participant is an offline PoC subscriber.

40. The method of claim 34 wherein the participant is a non-PoC subscriber.

41. A Push to Talk over Cellular (“PoC”) client for carrying out a PoC exchange over a network between PoC subscribers, non-PoC subscribers, and offline PoC subscribers, comprising a plurality of stored program instructions for:
identifying a participant in the PoC exchange as other than an online PoC subscriber;
converting a PoC communication into a PoC message compatible with a platform used by the participant; and
communicating the PoC message to the platform of the participant over the network.

42. The PoC client of claim 41 further comprising stored program instructions for communicating with the platform of the participant over the network to receive a response to the PoC message from the participant.

43. The PoC client of claim 42 further comprising stored program instructions for rendering the response for viewing by the PoC subscriber.

44. The PoC client of claim 43 wherein the response is a file that is pushed, pulled, or linked, and that comprises audio, video or image content.

45. The communications client of claim 41 wherein the communications client is a PoC mobile phone, a PoC personal data assistant, or a PoC notebook computer, the stored program instructions being stored thereon as a client application.

46. The communications client of claim 41 wherein the communications client is a digital information storage medium, the stored program instructions being stored thereon as a client application.
